(19) United States
(12) Patent Application Publication
(10) Pub. No.: US 2009/0139911 A1
(43) Pub. Date: Jun. 4, 2009

(54) METHOD OF DETECTING DEFECTIVE CONTAINERS

(75) Inventors: Ronald Lisec, Chester, SC (US); Brittney Palmer, Mars, PA (US); Jiansheng Tang, Mars, PA (US); Dennis H. Piispanen, Beaver, PA (US); Michael T. Williams, Beaver Falls, PA (US); Robert Heffern, McDonald, PA (US)

Correspondence Address: NOVA Chemicals Inc., Westpointe Center, 1550 Coraopolis Heights Road, Moon Township, PA, 15108, US

(73) Assignees: NOVA CHEMICALS INC., Moon Township, PA (US); DR. RONALD LISEC, D/B/A LISEC INDUSTRIES INC., Chester, SC (US)

(21) Appl. No.: 11/948,028

(22) Filed: Nov. 30, 2007

(51) Int. Cl. G01M 3/38; B07C 5/00

(52) U.S. Cl. 209/576; 209/597; 209/617

(57) ABSTRACT

Methods for identifying defective containers that include a) providing a container having an open rim end, a closed base end, an exterior surface and an interior surface; b) directing one or more sources of electromagnetic radiation toward the exterior surface or interior surface of the container; c) positioning one or more sensors for the electromagnetic radiation opposite the exterior or interior surface not directed to in b); d) accepting the container if the amount of electromagnetic radiation detected by the one or more sensors is within a predetermined range; and e) rejecting the container if the amount of electro-magnetic radiation is not within the predetermined range. The methods can be used in devices that contain a) conveying means for moving containers; b) means for directing sources of electromagnetic radiation; c) means for detecting electromagnetic radiation; and d) means for separating containers.

### BACKGROUND OF THE INVENTION

1. Field of the Invention

The present invention is directed to methods of manufacturing and testing cups and containers and in particular those that are made from expanded thermoplastic materials.

2. Description of the Prior Art

Containers used for liquid or solid foodstuffs (e.g., drinking cups, containers for frozen confections and the like) are required to be substantially leak-proof so that the filled containers may be handled reliably during shipping and/or consumer usage with minimal risk of the contents leaking and thereby creating an inconvenient mess or bodily harm. In this regard, containers made from expandable thermoplastics particles (beads of expandable polystyrene or EPS, for example), sometimes referred to as foam cups, have a base molded to a generally cylindrical side wall and are susceptible to leakage when proper fusion of expandable particles is not achieved.

Typically, therefore, foam cup manufacturers will spot-check containers for leakage by subjecting a number of containers representing a sample of containers made during a given manufacturing run to manual leak-tests. That is, a representative number of containers for a given manufacturing run will be filled with a dyed liquid and allowed to stand for a period of time so that any leaks may be readily determined visually by the leak-test operator. If several containers from the representative sample are identified as “leakers”, the cause of such defective containers is then investigated by down-time inspection of the machine which was responsible for the container manufacture. During the time that leakage problems are detected, a substantial number of potentially defective containers could be manufactured due to the high-speed operation of the container manufacturing machine thereby potentially requiring the container manufacturer to scrap an entire run of containers during that time period. Since the manufacturer cannot guarantee that all containers made during that time period are defective, there is a real risk that acceptable containers are scrapped along with any defective containers that may have been made. Clearly, such a procedure amounts to potential significant waste of resources and decreased productivity.

Recently, the manufacture of foam cups and containers has become further complicated by first placing a label in a cup or container mold and then molding a foam cup or container that has a label molded about the outside of the side wall. Methods of producing such “in-mold” labeled foam cups and containers are disclosed for example in US Patent Application Publication 2007/0042144 and International Application Nos. WO0185420 and WO2006017872.

When a label is not positioned in a mold correctly, the possibility of leakers is increased and the need for detecting leakers also becomes more important.

Various apparatus and methods have been developed to attempt to detect leaks in various vessels, bottles, cups and containers, for example, those disclosed in U.S. Pat. Nos. 3,712,112; 3,813,923; 3,949,598; 4,708,014; 4,896,530; 5,205,157; 5,239,859; 5,333,491; 5,641,661; 5,317,902; 5,319,957; 5,939,620; 6,050,134; 6,745,103; and 7,000,456.

There are numerous issues with the methods and apparatus disclosed in the foregoing patents. First, many are not readily adaptable to being retrofitted into existing foam container manufacturing lines. Second, many of the methods rely on vacuum, which can detect a hole. Lastly, many of the foregoing methods simply do not identify structural defects and miss some leakers.

It would, therefore, be desirable to have an automatic container leak testing apparatus and method, which could easily be retrofitted onto existing container-making machinery and reliably identify leakers, probable leakers, and structural defects in foam containers.

### SUMMARY OF THE INVENTION

The present invention is directed to a method for identifying defective containers that includes a) providing a container having an open rim end, a closed base end, an exterior surface and an interior surface; b) directing one or more sources of electromagnetic radiation toward the exterior surface or interior surface of the container; c) positioning one or more sensors for the electromagnetic radiation opposite the exterior or interior surface not directed to in b); d) accepting the container if the amount of electro-magnetic radiation detected by the one or more sensors is within a predetermined range; and e) rejecting the container if the amount of electromagnetic radiation is not within the predetermined range.

The present invention also provides a method of identifying defective containers from non defective containers that includes a) providing a set of containers having an open rim end, a closed base end, an exterior surface and an interior surface; b) establishing a threshold level of detectable electro-magnetic radiation that identifies a defective container; c) directing one or more sources of electro-magnetic radiation toward the exterior surface or interior surface of a container at an inspection position; d) positioning one or more sensors for the electromagnetic radiation opposite the exterior or interior surface not directed to in c) at the inspection position; e) providing signals from the sensors to a central processing unit (CPU) communicating the amount of electromagnetic radiation detected by each sensor; f) comparing the amount of electromagnetic radiation detected by each sensor to the threshold value; and g) using a signal from the CPU to cause the removal of the container from the set of containers when the amount of electromagnetic radiation detected by at least one sensor is greater than the threshold value.

The present invention additionally provides a device for removing defective containers. The containers have an open rim end, a closed base end, an exterior surface, and an interior surface. The device includes a) conveying means for moving containers to an inspection position; b) means for directing one or more sources of electromagnetic radiation with a peak wave-length of from 380 to 1400 nm toward the exterior surface or interior surface of a container at an inspection position; c) means for detecting electro-magnetic radiation opposite the exterior or interior surface not directed to in b) at the inspection position; and d) a directing means for separating containers based on the amount of electromagnetic radiation detected by the means for detecting electromagnetic radiation.

### DESCRIPTION OF THE DRAWINGS

FIG. 1 is a top plan view of a container that can be used in the methods and devices in the present invention;

FIG. 2 is a side elevation view of a container that can be used in the methods and devices in the present invention;

FIG. 3 is a top plan view of a container that can be used in the methods and devices in the present invention;

FIG. 4 is a side elevation view of a container that can be used in the methods and devices in the present invention;

FIG. 5 is a schematic diagram depicting an embodiment of the present invention;

FIG. 6 is a schematic diagram depicting an embodiment of the present invention;

FIG. 7 is a schematic diagram depicting an embodiment of the present invention;

FIG. 8 is a top plan view of a container that can be used in the methods and devices in the present invention;

FIG. 9 is a side elevation view of a container that can be used in the methods and devices in the present invention;

FIG. 10 is a schematic diagram depicting an embodiment of the present invention;

FIG. 11 is a schematic diagram depicting an embodiment of the present invention; and

FIG. 12 is a schematic diagram depicting an embodiment of the present invention.

### DETAILED DESCRIPTION OF THE INVENTION

For the purpose of the description hereinafter, the terms “upper”, “lower”, “inner”, “outer”, “right”, “left”, “vertical”, “horizontal”, “top”, “bottom”, and derivatives thereof, shall relate to the invention as oriented in the drawing Figures. However, it is to be understood that the invention may assume alternate variations and step sequences except where expressly specified to the contrary. It is also to be understood that the specific devices and processes, illustrated in the attached drawings and described in the following specification, is an exemplary embodiment of the present invention. Hence, specific dimensions and other physical characteristics related to the embodiment disclosed herein are not to be considered as limiting the invention. In describing the embodiments of the present invention, reference will be made herein to the drawings in which like numerals refer to like features of the invention.

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers and graft copolymers.

The present invention provides methods of detecting defects in containers. As used herein, “defects” refers to a portion of a container that allows liquids to leak from the confines of the container when placed therein, as well as surface imperfections, such as, but not limited to, label misalignment for labeled containers and structural issues, that, as a non-limiting example, cause a decrease in the rim strength of the container.

As used herein, the terms “leak”, “leaking” and “leakage” generally refer to a container's inability to contain a liquid within its confined volume either through the liquid flowing through a hole or other orifice in the container or otherwise seeping, migrating or escaping from the confined volume of the container.

As used herein, the terms “central processing unit” or “CPU” refer to a class of logic machines that can execute a sequence of instructions or computer programs and includes without limitation micro-processors, digital computers, integrated circuits, fixed-program computers, and other machines capable of performing a sequence of fetch, decode, execute, and writeback functions.

The present invention provides a method for identifying defective containers that includes:
a) providing a container having an open rim end and a closed base end;
b) directing one or more sources of electromagnetic radiation toward the exterior surface of the base end of the container;
c) positioning one or more sensors for the electromagnetic radiation opposite the open end;
d) accepting the container if the amount of electromagnetic radiation detected by the one or more sensors is within a predetermined range; and
e) rejecting the container if the amount of electromagnetic radiation is not within the predetermined range.

The present method can be used with all types of containers used to hold liquids and is especially suitable for drinking cups and small bowls and buckets used for packaging, serving and consuming food or beverages. The containers used in the present invention can be made of paper, plastics or other materials known in the art.

In particular embodiments of the invention, the containers include expandable resin beads molded in a shape having a sidewall, which may also be referred to as “foam containers”.

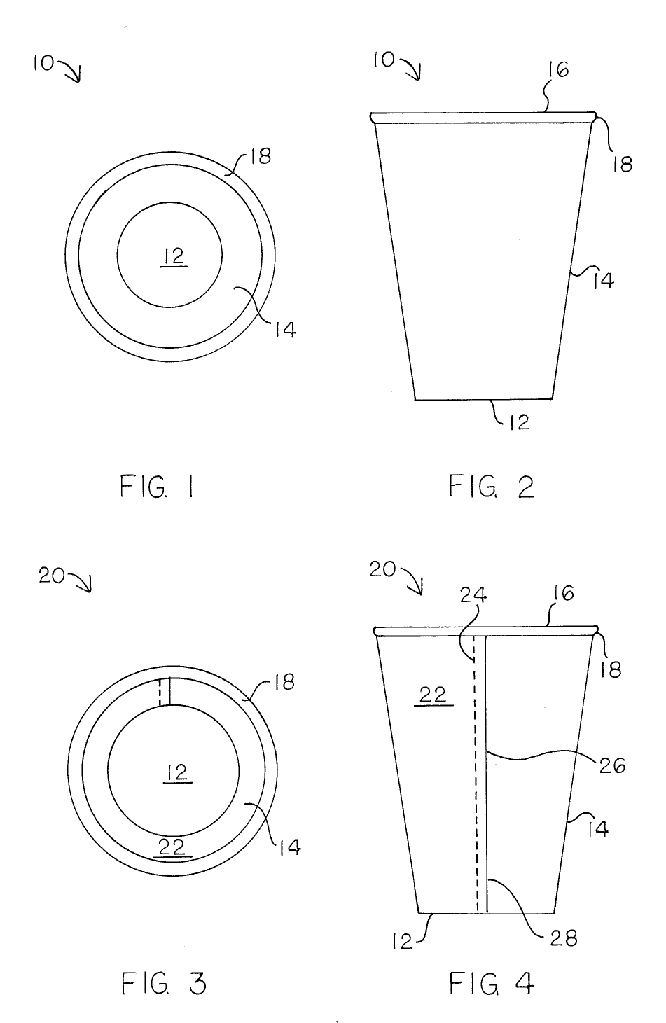

Containers as shown in FIGS. 1 and 2 can be used in various embodiments of the invention. As such, container 10 is circular shape in plan and include base 12 and a side wall 14 extending upwardly and outwardly from base 12 to a mouth 16 at the top of container 10 where side wall 14 terminates in an annular rim 18, which projects radially outwardly from side wall 14 about mouth 16 of container 10.

In particular embodiments of the invention, shown in FIGS. 3 and 4, labeled container 20 can be used in the present method. Labeled container 20 is similar in many respects to container 10 and includes base 12, side wall 14, mouth 16, annular rim 18 as well as label 22, which includes first end 24 and second end 26, which can overlap to form a seam indicated by an edge 28 of second end 26 where they meet along side wall 14. In embodiments of the invention, a heat sensitive adhesive can be applied to at least a portion of a bottom surface of label 22 to aid in attachment to container 20. In embodiments of the invention, a heat sensitive adhesive can be applied to the top surface of label 22 to aid attachment of second end 26 to first end 24.

Label 22 can be any suitable film disposed over at least a portion of an outer surface of sidewall 14 of container 20.

Suitable materials for the film or label include, but are not limited to thermoplastic resins, cellulose based paper, and synthetic paper.

Any suitable thermoplastic resin can be used. Suitable thermoplastic resins include, but are not limited to one or more selected from polyolefinic resins, ethylene-acrylic acid copolymers, ethylene-C₁-C₁₂ alkyl(meth)acrylate ester copolymers, metal salts of ethylene-methacrylic acid copolymers, poly(4-methyl-1-pentene), polyethylene terephthalate resins, poly-vinyl chloride resins, polyamide resins, ABS resins, and combinations thereof.

Any suitable polyolefinic resin can be used. Suitable polyolefinic resins include, but are not limited to propylene resins, high-density polyethylene, medium-density polyethylene, linear low-density polyethylene, ethylene-cyclic olefin copolymers, copolymers of propylene and one or more α-olefins, and combinations thereof.

Suitable synthetic papers that can be used in the invention include, without limitation, resin-coated paper, polyesters, microporous materials such as polyethylene polymer-containing material sold by PPG Industries, Inc., Pittsburgh, Pa. under the trade name of TESLIN®, a non-limiting example of which are those disclosed in U.S. Pat. No. 6,066,594, the relevant portions of which are incorporated herein by reference, TYVEK® synthetic paper available from E.I. DuPont de Nemours and Company, Wilmington, Del., OPPALYTE® films available from Mobil Oil Corp., New York, N.Y., other composite films listed in U.S. Pat. No. 5,244,861, the relevant portions of which are incorporated herein by reference, melt-extrusion-coated paper, and biaxially oriented support laminates, such as those described in U.S. Pat. Nos. 5,853,965; 5,866,282; 5,874,205; 5,888,643; 5,888,681; 5,888,683; and 5,888,714, the relevant portions of which are incorporated herein by reference.

In an embodiment of the invention, the film or label has a melting point of at least 120° C., in some cases greater than 130° C., in other cases greater than 135° C. and in some instances greater than 140° C.

The thickness of the film or label can vary based on the type of label material. As such the film or label can be at least 10 μm, in some cases at least 25 μm and in other cases at least 50 μm thick and can be up to 1,500 μm, in some cases up to 1,250 μm, in other cases up to 1,000 μm, in some instances up to 750 μm and in other instances up to 500 μm thick. The thickness of the film or label can be any value or range between any of the values recited above.

Any suitable heat sensitive adhesive can be used in the invention. Suitable heat sensitive adhesives include, but are not limited to ethylene-vinyl acetate copolymers, polyolefin resins, polyester resins, polyester-amide resins, polyamide resins, thermoplastic elastomers, acrylic resins, cellulosic resins, print lacquers and combinations thereof.

In embodiments of the invention, the containers can be molded from expandable resin beads using methods known in the art. As non-limiting examples, those methods disclosed in U.S. Pat. Nos. 3,125,780 or 4,065,531 or U.S. Patent Application Publication 2003/0146533 A1 can be used.

A film or label can be disposed over at least a portion of the outer surface of the sidewall of the containers using methods known in the art.

In some embodiments of the invention, labels can be affixed to the molded containers using a so-called “post-molding technique” that includes molding a container and subsequently wrapping/affixing a label to an exterior surface of the container, as a non-limiting example, using the methods described in U.S. Patent Application Publication 2006/0005917 A1.

In other embodiments of the invention, containers can be molded with labels, so-called “in-mold” labeled containers as disclosed in, without limitation, U.S. Patent Application Publication 2007/0042144 A1, WO 01/85420 A1 or WO 2006/017872 A1.

In such containers, any suitable expandable resin beads or pre-expanded resin beads can be used. Suitable resin beads include but are not limited to, those that contain homopolymers of vinyl aromatic monomers; copolymers of at least one vinyl aromatic monomer with one or more of divinylbenzene, conjugated dienes, alkyl(meth)acrylates, (meth)acrylonitrile, olefins, and/or maleic anhydride; polyolefins; poly-carbonates; polyesters; polyamides; natural rubbers; synthetic rubbers; and combinations thereof.

Suitable vinyl aromatic monomers include, but are not limited to, styrene, isopropylstyrene, alpha-methylstyrene, nuclear methylstyrenes, chlorostyrene, tert-butylstyrene. In an embodiment of the invention, the vinyl aromatic monomers can be copolymerized with one or more other monomers, non-limiting examples being divinylbenzene, conjugated dienes (non-limiting examples being butadiene, isoprene, 1,3- and 2,4-hexadiene), alkyl methacrylates, alkyl acrylates, acrylonitrile, and maleic anhydride, where the vinyl aromatic monomer is present in at least 50% by weight of the copolymer. In many embodiments of the invention, styrenic polymers are used, particularly polystyrene, however, other suitable polymers can be used, such as polyolefins (e.g., polyethylene, polypropylene), polycarbonates, polyphenylene oxides, and mixtures thereof.

In a particular embodiment of the invention, the expandable resin beads include expandable polystyrene (EPS) particles.

The resin beads are often impregnated with a blowing agent and then pre-expanded to a density similar to the desired density of the container base and sidewall. As such, the molded expandable resin beads will have a density of from about 0.5 lb./ft.³, in some cases about 1 lb./ft.³, in other cases about 2 lb./ft.³ and in other cases about 3 lb./ft.³ and can have a molded expandable resin bead density of up to about 12 lb./ft.³, in some cases up to about 10 lb./ft.³, in other cases up to about 8 lb./ft.³ , and in some instance up to about 6 lb./ft.³. The molded expandable resin bead density can be any value or range between any of the values recited above.

In embodiments of the invention, the base and sidewall can independently have a thickness of at least about 0.75 mm, in some cases at least about 1 mm, and in other cases at least about 1.25 mm and the thickness can be up to about 5 mm, in some cases about 4 mm and in other cases about 3 mm. The thickness of the base and sidewall can independently be any value or range between any of the values recited above.

As indicated above, the container can include an annular rim at the open end of the container where the sidewall terminates projecting radially outwardly from the sidewall. In embodiments of the invention, the container is a cup or bowl.

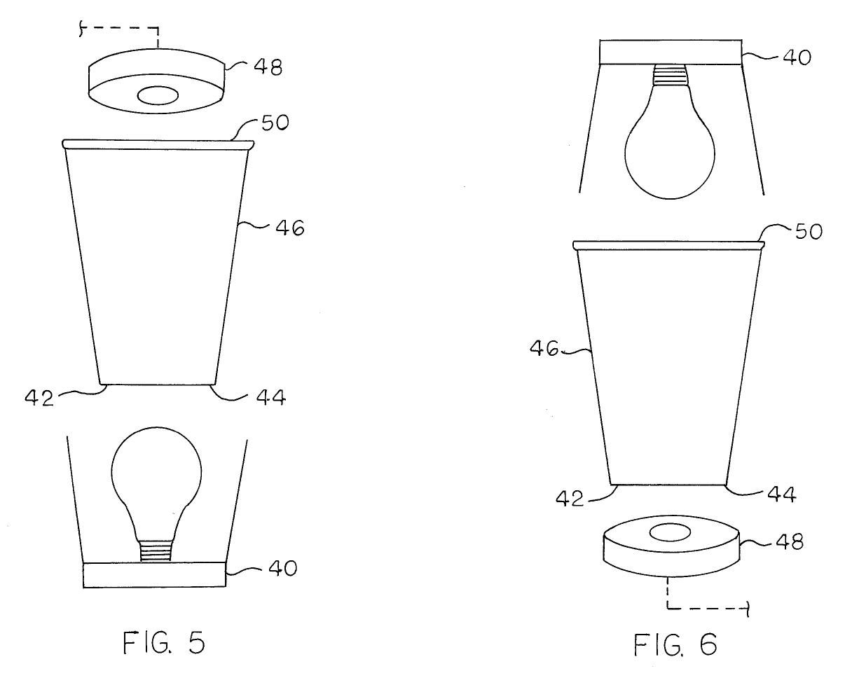

In embodiments of the invention as shown in FIG. 5, one or more sources 40 of electromagnetic radiation are directed toward exterior surface 42 of base end 44 of container 46 and one or more sensors 48 for the electromagnetic radiation are positioned opposite open end 50 of container 46.

In another embodiments of the invention as shown in FIG. 6, one or more sources 40 of electromagnetic radiation are directed toward open end 50 of container 46 and an interior surface therein of container 46 and one or more sensors 48 for the electromagnetic radiation are positioned opposite base end 44 of container 46.

In FIGS. 5 and 6 outputs from sensors 48 are directed to a CPU or controller, which can be included as part of a device adapted to carry out the present method. If, based on the response from sensors 48 a container is determined to contain a leak or otherwise be defective, the CPU or controller will therefore output a signal to a switch or control valve. Thus, a defective container 46 will be separated from non-defective containers 46 using one or more methods as described herein.

In various embodiments of the invention, the electromagnetic radiation includes one or more sources of electromagnetic radiation selected from visible light, infrared radiation, and ultraviolet radiation; including, but not limited to the range of from about 380 nm to about 1400 nm.

In particular embodiments of the invention, the electromagnetic radiation has a peak wavelength of from at least about 380 nm, in some cases at least about 400 and in other cases at least about 450 nm and can be up to about 1400 nm, in some cases up to about 1200 nm, in other cases up to about 1000 nm, in other cases up to about 850 nm, in some instances up to about 750 nm and in other instances up to about 700 nm. The particular wavelength employed can depend on the type of defect being detected, the type of sensor employed and the type of materials used to manufacture the containers. The peak wavelength of the electromagnetic radiation used in the present invention can be any value or range between any of the values recited above.

In various embodiments of the invention, the sensors can be any electromagnetic radiation detection device, as a non-limiting example, any device that detects electromagnetic radiation in the range of about 380 nm to 1400 nm, and can include without limitation one or more selected from digital cameras, light-addressable potentiometric sensors, image sensors, a photoswitch, a gonioreflectometer, reflective optical sensors, triangulation sensors, and passive infrared sensors.

In various embodiments of the present invention, the method for identifying defective containers is used as part of a larger method of removing defective containers from a set of containers. In its most general sense, the method for identifying defective containers is applied to each container individually and containers that are identified as being defective are physically separated from those containers that are not identified as being defective.

When the method for identifying defective containers is applied, a sensor is utilized to detect electromagnetic radiation that passes through the base and/or sidewall of a container. Threshold levels of detectable electromagnetic radiation are first established by correlating the leaking tendency or defect characteristic of a container with the amount of electromagnetic radiation that passes through the base and/or sidewall of the container. A plurality of sensors can be used to simultaneously monitor electro-magnetic radiation penetrating the base and various portions of the sidewall of a container. When the amount of electromagnetic radiation detected by one or more sensors meets or exceeds the threshold level, the container is identified as defective and separated from the containers that are not identified as being defective.

Embodiments of the present invention are directed to a device for identifying defective containers that utilizes the above-described method. The device includes:
a) one or more conveying means for moving containers to an inspection position;
b) one or more means for directing one or more sources of electromagnetic radiation toward a first portion of the containers at the inspection position;
c) one or more means for detecting electromagnetic radiation opposite the first portion of the containers at the inspection position; and
d) one or more directing means for separating containers based on the amount of electro-magnetic radiation detected by the means for detecting electromagnetic radiation.

As used herein, the term “conveying means” refers to devices and methods, mechanical and manual, that transport and/or otherwise transfer containers from a first position, to an inspection position, and then to a final position.

Suitable conveying means that can be used in the invention include, but are not limited to a descrambler, a conveyer belt, a swing arm, a rotating table, and combinations thereof.

As used herein, the phrase “means for directing one or more sources of electromagnetic radiation” refers to any device or method that focuses or otherwise directs electromagnetic radiation to a specific portion of a container.

Suitable means for directing one or more sources of electromagnetic radiation can include, but are not limited to housings adapted to hold an electromagnetic radiation source in a predetermined position, movable housings adapted to hold an electromagnetic radiation source, mirrors, lenses, wavelength filters, IR filters, UV filters, visible light filters, dark field illuminators, light emitting diodes (LED), laser, focused beam, incandescent, strobe lighting (for example, using incandescent, LED, laser or dark field) and combinations thereof.

As used herein, the term “means for detecting electromagnetic radiation” refers to one or more sensors as described above.

In various embodiments of the invention, the conveying means can be housed within or adjacent to a device for making containers.

In various embodiments of the invention, the directing means for separating containers can include one or more selected from a compressed air nozzle that is activated based on the amount of electromagnetic radiation detected by the means for detecting electro-magnetic radiation; an arm that can include a grasping/pushing device that removes a container based on the amount of electromagnetic radiation detected by the means for detecting electromagnetic radiation; a switch on a conveyer that directs containers along one of two or more directions based on the amount of electromagnetic radiation detected by the means for detecting electromagnetic radiation; and vacuum.

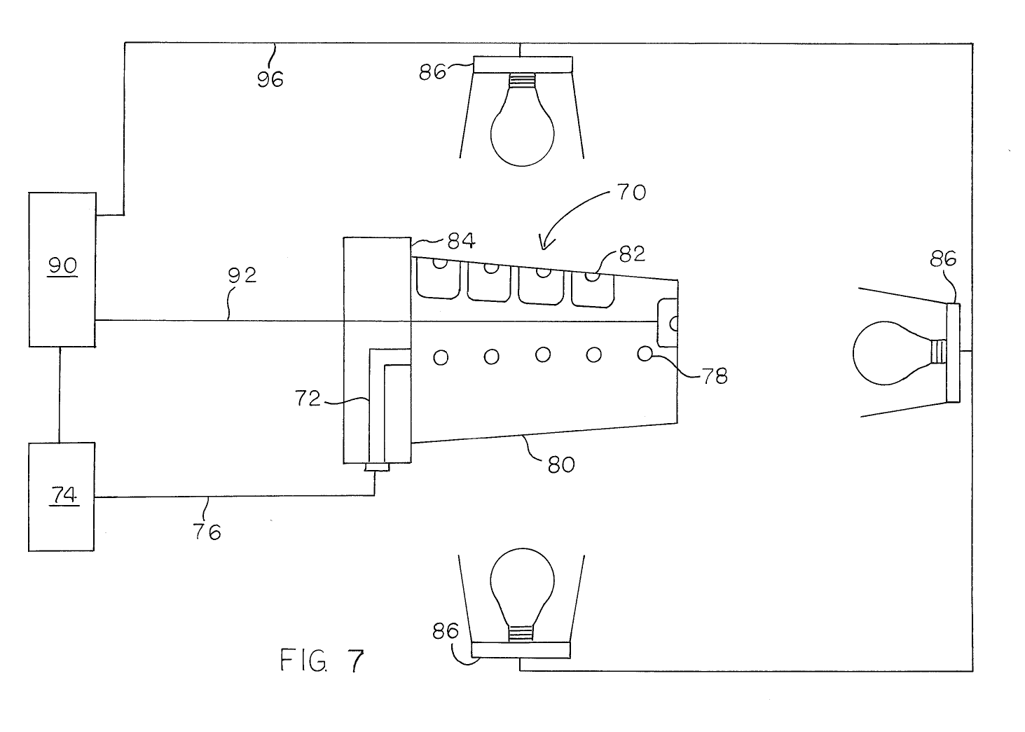

In embodiments of the invention as shown in FIG. 7, a CPU or controller 90 can output a signal to a switch or control valve when a defective container is identified. In some embodiments, a mandrel 70 is provided with an internal conduit 72, which is fluid-connected to a pressure switch 74 via pneumatic line 76 and to holes 78 exposed to outer surface 80 of mandrel 70. Mandrel 70 can also include sensors 82 or electromagnetic radiation sources (not shown).

In various embodiments, vacuum is applied to mandrel 70 via pneumatic line 76 and to holes 78 to hold a container in place against rim seat 84. When mandrel 70 includes sensors 82, electromagnetic radiation sources 86 external and directed to mandrel 70 are applied. Sensors 82 communicate with CPU or controller 90 via sensor line 92 and electromagnetic radiation sources 86 communicate with CPU or controller 90 via source line 96. When a container is held against rim seat 84, CPU or controller 90 signals electromagnetic radiation sources 86 to emit electromagnetic radiation and CPU or controller 90 then monitors the response from sensors 82. If the response from one or more of sensors 82 exceeds a threshold level, a container is identified as defective.

In some embodiments, the amount of vacuum drawn by pneumatic line 76 via holes 78 is also monitored by CPU or controller 90 based on the input from a pressure transducer in pressure switch 74. If a threshold pressure is exceeded, a container can be identified as defective.

Alternatively, mandrel 70 can contain electro-magnetic radiation sources 86 and sensors 82 can be external to mandrel 70 and can similarly signal CPU or controller 90 that a container is defective based on receiving an amount of electromagnetic radiation above a threshold level.

In embodiments of the invention, when mandrel 70 holds a defective container, it can be brought into registry with a reject chute or station and utilize compressed air flowing through pneumatic line 76 via holes 78 to remove the container from mandrel 70 and cause it to be transferred to a remote location for defective containers. If, on the other hand, a container is found to not be defective, the CPU will signal for the container to be indexed into registry with a non-defective container chute using compressed air as described above. As such, those containers determined to be non-defective can be segregated from those determined to be defective because sensor inputs and optionally pressure readings exceeded threshold values.

Thus, a compressed air nozzle as used in mandrel 70 can be activated based on the amount of electromagnetic radiation detected by a means for detecting electromagnetic radiation to direct containers to defective and non-defective receptacles.

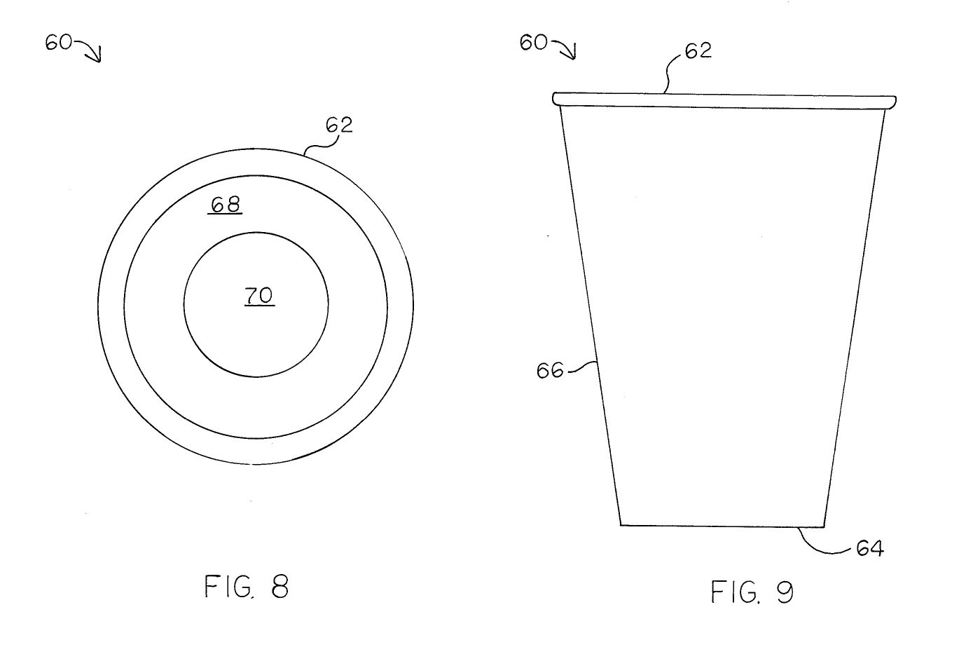

In various non-limiting embodiments of the invention, as shown in FIGS. 8 and 9, the first portion of a container 60 can be an open rim end 62, a closed base end 64, a portion of closed base end 64, a portion of the outside sidewall 66, a portion of the interior sidewall 68 or a portion of the interior base end 70.

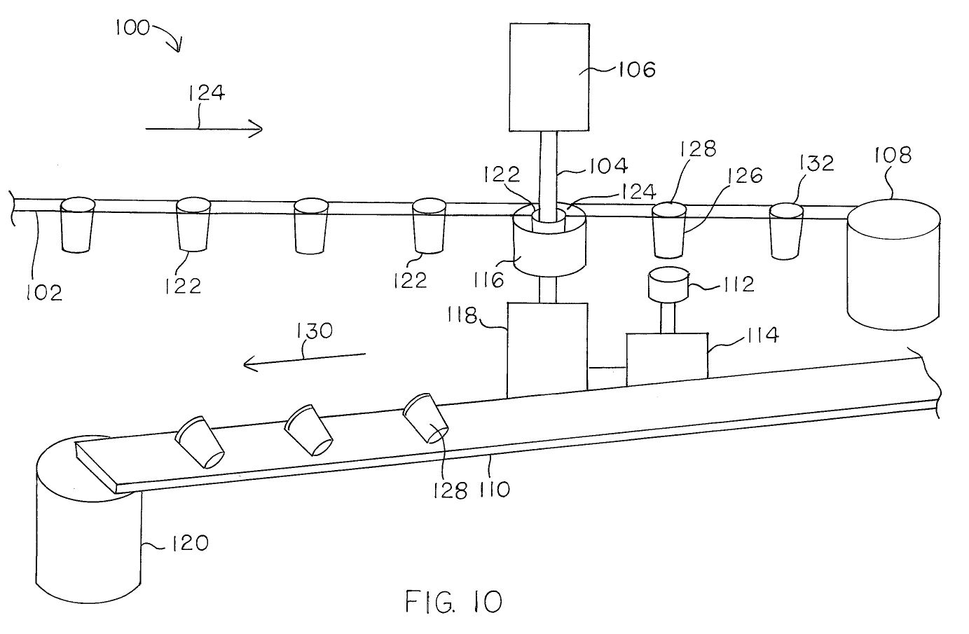

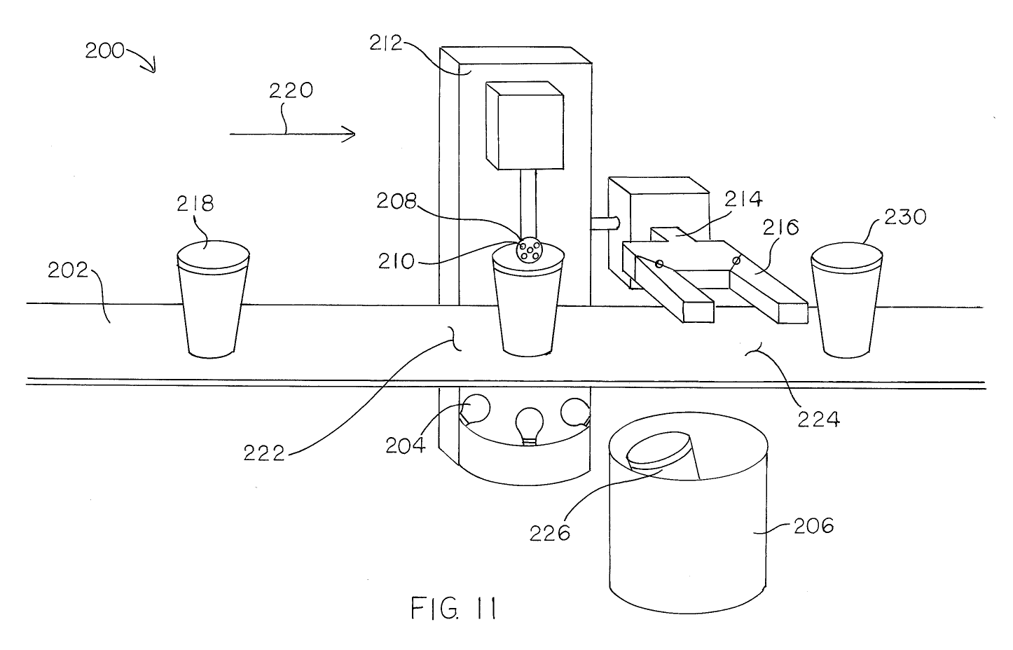

In a non-limiting alternative embodiment, compressed air can be used to remove defective containers from a conveying line. As shown as a non-limiting example in FIG. 10, container conveyer line 100 includes container line 102, electromagnetic radiation source 104 with controller 106, non-defective container bin 108, defective container line 110, compressed air blower 112, compressor 114, sensor bowl 116, controller 118, and defective container bin 120.

In operation, containers 122 are received from a container molding machine (not shown) onto container line 102, which transports containers 122 in direction 124. When container 122 reaches inspection station 124, controller 106 lowers electromagnetic radiation source 104 into the open rim end adjacent to the interior sidewall of container 122. Controller 118 raises sensor bowl 116 so that it surrounds the closed base end and at least a portion of the outside sidewall of container 122. Electromagnetic radiation source 104 emits electromagnetic radiation and the signals from the one or more sensors (as described above) in sensor bowl 116 are monitored by a central processing unit (CPU) in controller 118. If one or more signals from the sensors exceeds a threshold level, container 122 is designated as defective and proceeds to reject station 126.

When defective container 128 is at reject station 126, controller 118 activates compressor 114 and compressed air is expelled from compressed air blower 112 causing defective container 128 to leave container line 102 and enter defective container line 110. Defective container 128 is then transported along defective container line 110 in direction 130 and deposited in defective container bin 120.

If none of the signals from the sensors exceeds a threshold level, container 122 is designated as non-defective and proceeds through reject station 126 and non-defective container 132 is deposited in non-defective container bin 108.

In another non-limiting alternative embodiment, an arm that includes a grasping, grabbing and/or pushing device can be used to remove or separate a defective container from non-defective containers based on the amount of electromagnetic radiation detected by the means for detecting electromagnetic radiation.

As a non-limiting example of this embodiment, shown in FIG. 11, container conveyer line 200 includes container line 202, one or more electromagnetic radiation sources 204, defective container bin 206, sensor probe 208 that includes one or more electro-magnetic radiation sensors 210, controller 212, and arm 214 with grasping/pushing hand 216.

In operation, containers 218 are received from a container molding machine (not shown) onto container line 202, which is made from a transparent material and transports containers 218 in direction 220. When container 218 reaches inspection station 222, controller 212 lowers sensor probe 208 into the open rim end of container 218 adjacent to the interior sidewall of container 218. Electromagnetic radiation sources 204 emit electromagnetic radiation and the signals from the one or more sensors 210 in sensor probe 208 are monitored by a central processing unit (CPU) in controller 212. If one or more signals from sensors 210 exceeds a threshold level, container 218 is designated as defective and proceeds to reject station 224.

When defective container 226 reaches reject station 224, controller 212 activates arm 214 and causes grasping/pushing hand 216 to move defective container 226 from container line 202 to defective container bin 206.

If none of the signals from sensors 210 exceeds a threshold level, container 218 is designated as non-defective and proceeds through reject station 224 and non-defective container 230 proceeds to a non-defective container repository (not show).

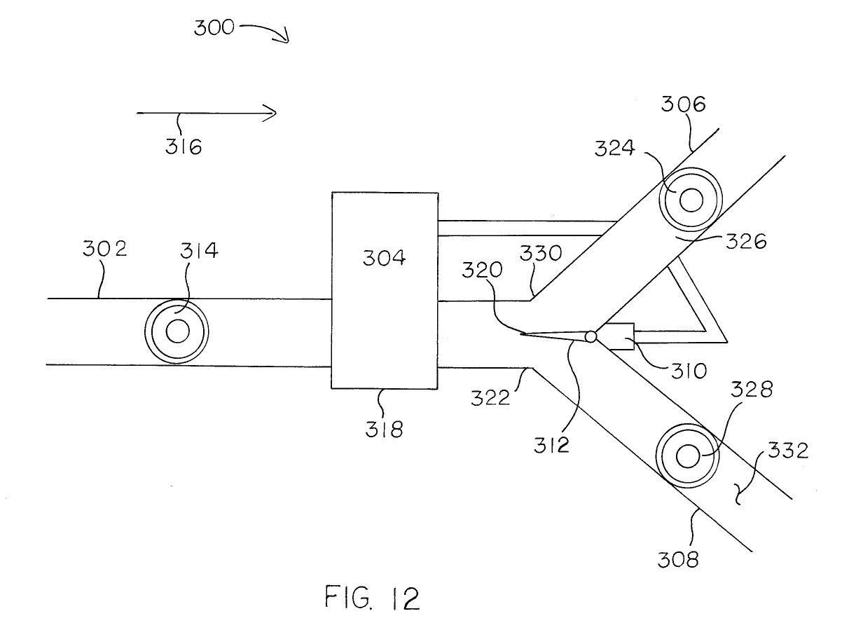

In a further non-limiting alternative embodiment, a switch on a conveyer can direct containers along one of two or more directions based on the amount of electromagnetic radiation detected by the means for detecting electromagnetic radiation. In this embodiment, shown in FIG. 12, container conveyer line 300 includes container line 302, controller 304, an electromagnetic radiation source and one or more electromagnetic radiation sensors (both hidden from view by controller 304) defective container line 306, non-defective container line 308, arm switch 310 and directional arm 312.

In operation, containers 314 are received from a container molding machine (not shown) onto container line 302, which transports containers 302 along direction 316. When container 314 reaches inspection station 318, controller 304 causes an electromagnetic radiation source (obscured by controller 304) into an open rim end adjacent to the interior sidewall of container 314 and one or more sensors (obscured by controller 304) surround the closed base end and at least a portion of the outside sidewall of container 314. The electromagnetic radiation source emits electromagnetic radiation and the signals from the one or more sensors are monitored by a central processing unit (CPU) in controller 304. If one or more signals from the sensors exceeds a threshold level, container 314 is designated as defective and end 320 of directional arm 312 is moved by arm switch 310 as directed by the CPU to defect position 322 and defective container 324 is directed along defect line 326 and is thereby separated from non-defective containers 328.

If none of the signals from the sensors exceeds a threshold level, container 314 is designated as non-defective container 328 and end 320 of directional arm 312 is moved by arm switch 310 as directed by the CPU to non-defect position 330 and non-defective container 328 is directed along non-defect line 332 and is thereby separated from defective containers 324.

Various embodiments of the invention are directed to a device for identifying defective containers from a set of containers. The containers, as described above, generally have an open rim end, a closed base end, an exterior surface, and an interior surface.

The device includes a) conveying means for moving containers to an inspection position; b) means for directing one or more sources of electromagnetic radiation with a peak wavelength of from 380 to 1400 nm (as described above) toward the exterior surface or interior surface of a container at an inspection position; c) means for detecting electromagnetic radiation opposite the exterior or interior surface not directed to in b) at the inspection position; and d) a directing means for separating containers based on the amount of electromagnetic radiation detected by the means for detecting electromagnetic radiation.

In embodiments of the invention, the electro-magnetic radiation can be directed toward the base end and exterior surface of the container and the sensors can be directed toward the open rim end and/or the interior surface.

In other various embodiments of the invention, the electromagnetic radiation can be directed toward the open rim end and/or the interior surface of the container and the sensors can be directed toward the base end and exterior surface.

Any suitable conveying means that can transport containers to an inspection station or position and then further transport the containers to separate areas for defective and non-defective containers can be used in the invention. Suitable conveying means include, but are not limited to a descrambler, a conveyer belt, a swing arm, a push arm, a robotic arm, a grasping/-pushing arm, a rotating table, and combinations thereof.

Any suitable means for directing a source of electromagnetic radiation that can produce and target electromagnetic radiation, in many cases electro-magnetic radiation having a wavelength of from about 380 nm to about 1400 nm as described above, on a surface of a container can be used in the invention. Suitable means for directing a source of electro-magnetic radiation include, but are not limited to infra red light filters, ultraviolet light filters, visible light filters, dark field illumination, light emitting diodes, laser focused beam, reflected light, incandescent light, strobe light, and combinations thereof.

Any suitable means for detecting electromagnetic radiation that can produce a signal, that can be interpreted by a central processing unit, proportional to the amount of electromagnetic radiation exposure can be used in the invention. Suitable means can include any electromagnetic radiation sensor for detecting electromagnetic radiation and can include, but is not limited to digital cameras, light-addressable potentio-metric sensors, image sensors, a photoswitch, a gonio-reflectometer, reflective optical sensors, triangulation sensors, passive infrared sensors and combinations thereof.

Any suitable directing means for separating containers that can accept a signal from a CPU and then effect the removal of a defective container from a set of containers can be used in the invention. Suitable directing means for separating containers include, but are not limited to a compressed air nozzle that is activated based on the amount of electromagnetic radiation detected by the means for detecting electro-magnetic radiation; an arm comprising a grasping/-pushing device that removes a container based on the amount of electromagnetic radiation detected by the means for detecting electromagnetic radiation; a switch on a conveyer that directs containers along one of two or more directions based on the amount of electro-magnetic radiation detected by the means for detecting electromagnetic radiation; and vacuum.

While various embodiments have been described above, it should be understood that they have been presented by way of example only, and not limitation. Thus, the breadth and scope of any embodiment should not be limited by any of the above described exemplary embodiments, but should be defined only in accordance with the following claims and their equivalents.

We claim:

1. A method for identifying defective containers comprising:
a) providing a container having an open rim end, a closed base end, an exterior surface and an interior surface;
b) directing one or more sources of electro-magnetic radiation toward the exterior surface or interior surface of the container;
c) positioning one or more sensors for the electromagnetic radiation opposite the exterior or interior surface not directed to in b);
d) accepting the container if the amount of electromagnetic radiation detected by the one or more sensors is within a predetermined range; and
e) rejecting the container if the amount of electromagnetic radiation is not within the predetermined range.

2. The method according to claim 1, wherein the electromagnetic radiation is directed toward the base end and exterior surface of the container and the sensors are directed toward the open rim end and/or the interior surface.

3. The method according to claim 1, wherein the electromagnetic radiation is directed toward the open rim end and/or the interior surface of the container and the sensors are directed toward the base end and exterior surface.

4. The method according to claim 1, wherein the container comprises expandable resin beads molded in a shape having a sidewall.

5. The method according to claim 4, wherein a film is disposed over at least a portion of the outer surface of the sidewall of the container.

6. The method according to claim 5, wherein the film comprises one or more materials selected from the group consisting of one or more thermoplastic resins, cellulose based paper, and synthetic paper.

7. The method according to claim 6, wherein the thermoplastic resins are selected from the group consisting of polyolefinic resins, ethylene-acrylic acid copolymers, ethylene-C₁-C₁₂-alkyl(meth)acrylate ester copolymers, metal salts of ethylene-methacrylic acid copolymers, poly(4-methyl-1-pentene), polyethylene terephthalate resins, polyvinyl chloride resins, polyamide resins, ABS resins, and combinations thereof.

8. The method according to claim 4, wherein the expandable resin beads comprise one or more polymers selected from the group consisting of homopolymers of vinyl aromatic monomers; copolymers of at least one vinyl aromatic monomer with one or more of divinylbenzene, conjugated dienes, alkyl (meth)acrylates, (meth)acrylo-nitrile, olefins, and/or maleic anhydride; polyolefins; polycarbonates; polyesters; polyamides; natural rubbers; synthetic rubbers; and combinations thereof.

9. The method according to claim 4, wherein the sidewall has a thickness of from 0.75 to 5 mm.

10. The method according to claim 4, wherein the molded expandable resin beads have a density of from 0.5 to 12 lb./ft.³.

11. The method according to claim 8, wherein the vinyl aromatic monomers are selected from the group consisting of styrene, isopropylstyrene, alpha-methylstyrene, nuclear methylstyrenes, chloro-styrene, tert-butylstyrene, and combinations thereof.

12. The method according to claim 8, wherein the polymers are selected from the group consisting of polystyrene, polyolefins, polycarbonates, polyphenylene oxides, and mixtures thereof.

13. The method according to claim 4, wherein the resin beads comprise expandable polystyrene particles.

14. The method according to claim 1, wherein the container is a cup or bowl.

15. The method according to claim 4, wherein the container comprises an annular rim at the open end of the container where the sidewall terminates projecting radially outwardly from the sidewall.

16. The method according to claim 1, wherein the electromagnetic radiation includes one or more selected from the group consisting of visible light, infrared radiation, strobe lighting and ultraviolet radiation.

17. The method according to claim 16, wherein the electromagnetic radiation has a wavelength of from about 380 nm to about 1400 nm.

18. The method according to claim 1, wherein the sensors include one or more selected from the group consisting of digital cameras, light-addressable potentiometric sensors, image sensors, a photoswitch, a gonioreflectometer, reflective optical sensors, triangulation sensors, and passive infrared sensors.

19. A method of identifying defective containers from non defective containers comprising:
a) providing a set of containers having an open rim end, a closed base end, an exterior surface and an interior surface;
b) establishing a threshold level of detectable electromagnetic radiation that identifies a defective container;
c) directing one or more sources of electro-magnetic radiation toward the exterior surface or interior surface of a container at an inspection position;
d) positioning one or more sensors for the electromagnetic radiation opposite the exterior or interior surface not directed to in c) at the inspection position;
e) providing signals from the sensors to a central processing unit (CPU) communicating the amount of electromagnetic radiation detected by each sensor;
f) comparing the amount of electromagnetic radiation detected by each sensor to the threshold value; and
g) using a signal from the CPU to cause the removal of the container from the set of containers when the amount of electromagnetic radiation detected by at least one sensor is greater than the threshold value.

20. A device for removing defective containers, said containers having an open rim end, a closed base end, an exterior surface, and an interior surface the device comprising:
a) conveying means for moving containers to an inspection position;
b) means for directing one or more sources of electromagnetic radiation with a peak wavelength of from 380 to 1400 nm toward the exterior surface or interior surface of a container at an inspection position;
c) means for detecting electromagnetic radiation opposite the exterior or interior surface not directed to in b) at the inspection position; and
d) a directing means for separating containers based on the amount of electromagnetic radiation detected by the means for detecting electromagnetic radiation.

21. The device according to claim 20, wherein the conveying means is one or more selected from the group consisting of a descrambler, a conveyer belt, a swing arm, a rotating table, and combinations thereof.

22. The device according to claim 20, wherein the means for directing a source of electromagnetic radiation is selected from the group consisting of infra red light filters, ultraviolet light filters, visible light filters, dark field illumination, light emitting diodes, laser focused beam, reflected light, incandescent light, strobe lighting, and combinations thereof.

23. The device according to claim 20, wherein the means for detecting electromagnetic radiation is one or more selected from the group consisting of digital cameras, light-addressable potentiometric sensors, image sensors, a photoswitch, a gonioreflectometer, reflective optical sensors, triangulation sensors, passive infrared sensors, and combinations thereof.

24. The device according to claim 20, wherein the directing means for separating containers is one or more selected from the group consisting of:
a compressed air nozzle that is activated based on the amount of electromagnetic radiation detected by the means for detecting electromagnetic radiation;
an arm comprising a grasping/pushing device that removes a container based on the amount of electromagnetic radiation detected by the means for detecting electromagnetic radiation;
a switch on a conveyer that directs containers along one of two or more directions based on the amount of electromagnetic radiation detected by the means for detecting electromagnetic radiation; and
vacuum.

25. The device according to claim 20, wherein the electromagnetic radiation is directed toward the base end and exterior surface of the container and the sensors are directed toward the open rim end and/or the interior surface; or
wherein the electromagnetic radiation is directed toward the open rim end and/or the interior surface of the container and the sensors are directed toward the base end and exterior surface.
